(19) United States
(12) Patent Application Publication
(10) Pub. No.: US 2012/0317112 A1
(43) Pub. Date: Dec. 13, 2012

(54) OPERATION LOG MANAGEMENT SYSTEM AND OPERATION LOG MANAGEMENT METHOD

(75) Inventor: Tomotada Naito, Yokohama (JP)

(73) Assignee: Hitachi, Ltd.

(21) Appl. No.: 13/260,218

(22) PCT Filed: Jun. 8, 2011
(86) PCT No.: PCT/JP2011/063166

§ 371 Date: Sep. 23, 2011

(51) Int. Cl. G06F 17/30

(52) U.S. Cl. 707/737; 707/E17.046

(57) ABSTRACT

In an example of operation log management system, a storage device stores a plurality of operation log records obtained from an operation log in a client computer. The plurality of operation log records each contains an operation type of a corresponding operation and a group identifier for identifying a group to which the corresponding operation belongs. Each of at least a part of the plurality of operation log records contains at least one of identifiers of input data and output data of a corresponding operation. A processor groups the plurality of operation log records into groups by the group identifiers, identifies operation log records which belong to different groups and whose output data identifier and input data identifier match, and associates the different groups to which the identified operation log records belong as components of one integrated group. A display device displays information representing the integrated group.

### BACKGROUND

This invention relates to management of an operation log acquired by a client computer.

In a computer system in which a client computer used by a user and a server computer are communicably connected by a network, there is a need to collect a log generated by the client computer and keep track of a history of various operations on the client computer based on the collected log. For example, WO 2010/112960 A1 (Patent Literature 1) discloses a technique of determining a configuration change that caused an invocation failure of an application program without the need for a knowledge database.

In recent years, there is an increasing need for keeping track of the task proceeding of a user against the background of improving the task efficiency and increasing compliance. Among others, the need to monitor the task proceeding of a user through operations on the client computer by the user is especially high.

To keep track of the task proceeding of a user, the server computer needs to collect and analyze an operation log (log events that have occurred from user operation) of the client computer used by the user. In the operation log of the user, it is often the case that one operation does not have a meaning in a task but a plurality of operations are collectively interpreted to have a meaning in the task. Therefore, a manager has had to browse through the operation log to estimate the user task.

### SUMMARY

However, the operation log is a huge amount of data, and the manager has borne a tremendous burden in referencing the operation log to estimate the user task. The manager may filter the operation log by specified items to estimate the user task from the selected operation log. However, the amount of the filtered operation log is not nevertheless small, and the burden on the manager is still large. Further, depending on the filtering method, the manager cannot estimate the user's task appropriately.

When the user performs a task, the user generally uses a plurality of windows, a plurality of processes, or a plurality of types of application. Therefore, the task performed by the user is a series of operations occurring on the plurality of objects. Therefore, in order to appropriately estimate the user's task from the operation log of the client computer, it is important to recognize association of the series of operations among the plurality of objects.

An operation log management system according to an aspect of this invention comprises a processor, a storage device and a display device for managing a user operation log in at least one client computer. The storage device stores a plurality of operation log records obtained from an operation log in the at least one client computer. The plurality of operation log records each contains an operation type of a corresponding operation and a group identifier for identifying a group to which the corresponding operation belongs. Each of at least a part of the plurality of operation log records contains at least one of an identifier of input data and an identifier of output data of a corresponding operation. The processor groups the plurality of operation log records into a plurality of groups by the group identifiers. The processor identifies operation log records which belong to different groups and whose output data identifier and input data identifier match. The processor associates the different groups to which the identified operation log records belong as components of one integrated group. The display device displays information representing the integrated group.

According to the aspect of this invention, the user task may be estimated appropriately from the operation log of the at least one client computer.

### BRIEF DESCRIPTION OF THE DRAWINGS

In the accompanying drawings:

FIG. 1 schematically illustrates an example configuration of a computer system including an operation log management system and a client computer according to an embodiment of this invention;

FIG. 2 schematically illustrates an example configuration of an operation log management server according to the embodiment of this invention;

FIG. 3A illustrates a part of an example of an operation log database according to the embodiment of this invention;

FIG. 3B illustrates another part of the example of the operation log database according to the embodiment of this invention;

FIG. 4 illustrates an example of an association definition table according to the embodiment of this invention;

FIG. 5 is an example flow chart of grouping of operation log records according to the embodiment of this invention;

FIG. 6 schematically illustrates a result obtained by grouping the operation log records by process IDs according to the embodiment of this invention;

FIG. 7 illustrates an example of a table of an operation log record group included in grouping data according to the embodiment of this invention;

FIG. 8 illustrates an example of a table of another operation log record group included in the grouping data according to the embodiment of this invention;

FIG. 9 illustrates an example of a table of still another operation log record group included in the grouping data according to the embodiment of this invention;

FIG. 10 illustrates an example of a table of yet another operation log record group of the grouping data according to the embodiment of this invention;

FIG. 11 illustrates an example of a table of yet another operation log record group included in the grouping data according to the embodiment of this invention;

FIG. 12 schematically illustrates a relationship between input and output data among the groups of the operation log records grouped by the process IDs according to the embodiment of this invention;

FIG. 13 illustrates an example of a table of an integrated operation log record group according to the embodiment of this invention;

FIG. 14 illustrates an example of a table of another integrated operation log record group according to the embodiment of this invention;

FIG. 15 illustrates an example of a group name table according to the embodiment of this invention;

FIG. 16 is an example flow chart of determining a group name according to the embodiment of this invention;

FIG. 17 illustrates an example of a user task list to be displayed according to the embodiment of this invention; and

FIG. 18 illustrates an example of task details to be displayed according to the embodiment of this invention.

### DETAILED DESCRIPTION OF THE PREFERRED EMBODIMENTS

Hereinafter, an embodiment of this invention is described with reference to the accompanying drawings. For clear description, specific details of the following description and the drawings are omitted and simplified where appropriate. Further, throughout the drawings, the same elements are denoted by the same reference symbols, and redundant description is omitted where necessary for clear description.

An operation log management system according to this embodiment puts a series of related operations in one group in the operation log of at least one client computer, and displays information representing the group to a manager. This way, the operation log management system effectively supports tracking of a user task by the manager.

Specifically, the operation log management system according to this embodiment identifies two operations of different operation log groups whose output and input data match. Those groups are presumed to be operations in the same user task. The operation log management system according to this embodiment associates and integrates those groups with each other. The operation log management system according to this embodiment displays information representing the integrated group to the manager, to thereby appropriately support the tracking of the user task by the manager.

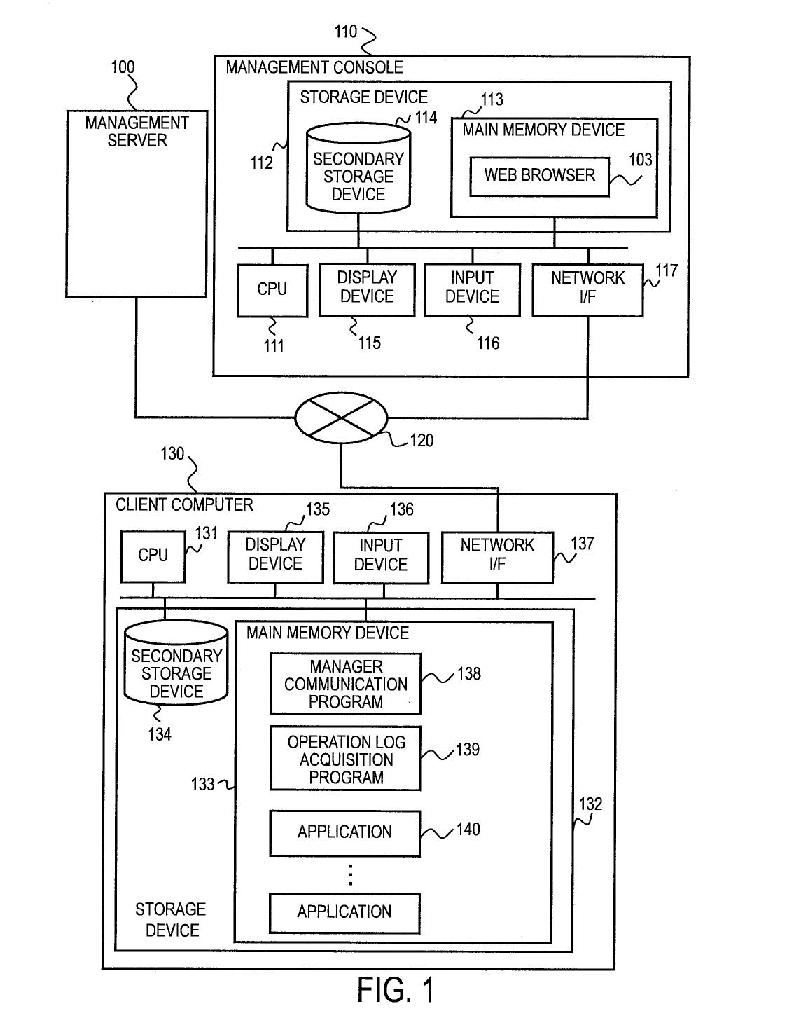

Hereinafter, operation log management according to this embodiment is described with reference to the accompanying drawings. FIG. 1 schematically illustrates an example configuration of a computer system including the operation log management system and a client computer operated by a user according to this embodiment. The management system includes a management server 100 and a management console 110. FIG. 1 illustrates one client computer 130 from which an operation log is to be obtained, but typically, a plurality of client computers are to be managed by the management system. The computers are communicably connected by a network 120.

The management console 110 is a computer used by the manager to manage the client computer 130. The manager accesses the management server 100 from the management console 110 to instruct the management server 100 on processing, and controls the management console 110 to acquire and display processing results of the management server 100. This way, the manager uses the management console 110 to perform user task management based on the operation log of the client computer 130. The operation log management system does not have to include the management console 110, and the manager may use an input/output device directly connected to the management server 100, instead of the management console 110.

As illustrated in FIG. 1, the management console 110 includes a CPU 111, which is a processor, a storage device 112, a display device 115, an input device 116, and a network interface 117. The management console 110 connects to the network 120 through the network interface 117.

The storage device 112 includes a main memory device 113 and a secondary storage device 114. The main memory device 113 is typically a volatile semiconductor memory, and stores a web browser 103, which is a program. The manager uses the web browser 103 to access and operate the management server 100.

The CPU 111 operates as a functional part (for example, display part) which realizes predetermined functions by executing programs stored in the main memory device 113. The programs to be executed include, in addition to the web browser 103 illustrated in FIG. 1, an operating system (OS) (not shown).

For convenience of description, the web browser 103 is illustrated in the main memory device 113, but typically, the web browser 103 is loaded from a storage region of the secondary storage device 114 to a storage region of the main memory device 113. The secondary storage device 114 is a storage device including a non-volatile, non-transitory storage medium for storing programs and data necessary for realizing predetermined functions. The secondary storage device 114 may alternatively be an external storage device connected through the network 120.

Typical examples of the input device 116 are a keyboard and a pointer device, but may alternatively be a device other than the keyboard and the pointer device. The display device 115 is typically a display monitor, and displays the processing results of the management server 100. Display contents of the display device 115 are described later.

The client computer 130 is a computer used by the user, who is to be managed. The client computer 130 acquires the operation log of the user who uses the client computer 130, and transmits the acquired operation log to the management server 100.

As illustrated in FIG. 1, the client computer 130 includes a CPU 131, which is a processor, a storage device 132, a display device 135, an input device 136, and a network interface 137. The client computer 130 connects to the network 120 through the network interface 137. Typical examples of the input device 136 are a keyboard and a pointer device and the display device 135 is typically a display monitor, but the input device 136 and the display device 135 may alternatively be a device other than the keyboard and the pointer device, and the display monitor, respectively.

The storage device 132 includes a main memory device 133 and a secondary storage device 134. The main memory device 133 is typically a volatile semiconductor memory, and stores, in addition to an OS (not shown), a manager communication program 138, an operation log acquisition program 139, and a plurality of application programs 140. Those programs are parts of an operation log client program, and operation of each program is described later in detail.

The CPU 131 may include a plurality of chips and a plurality of packages. The CPU 131 realizes predetermined functions by executing programs stored in the main memory device 133. For example, the CPU 131 operates in accordance with the operation log acquisition program 139 to operate as an operation log acquisition part. The same applies to the other programs. The client computer 130 is a device including those functional parts.

For convenience of description, the programs 138 to 140 are illustrated in the main memory device 133, but typically, the programs 138 to 140 are loaded from a storage region of the secondary storage device 134 to a storage region of the main memory device 133. The secondary storage device 134 is a storage device including a non-volatile, non-transitory storage medium for storing programs and data necessary for realizing predetermined functions. The secondary storage device 134 may alternatively be an external storage device connected through the network 120.

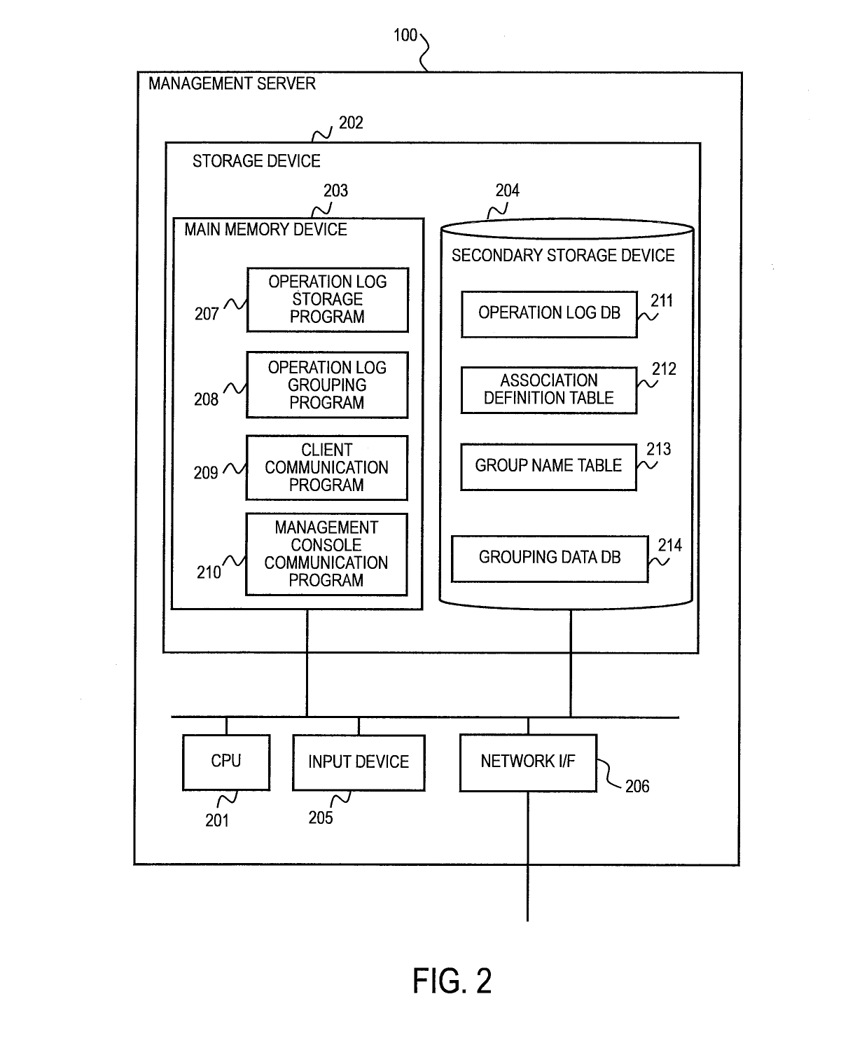

FIG. 2 schematically illustrates a configuration of the management server 100. The management server 100 is a computer, and includes a CPU 201, which is a processor, a storage device 202, an input device 205, and a network interface 206. The management server 100 connects to the network 120 through the network interface 206. Typical examples of the input device 205 are a keyboard and a pointer device, but may alternatively be a device other than the keyboard and the pointer device.

The storage device 202 includes a main memory device 203 and a secondary storage device 204. The main memory device 203 is typically a volatile semiconductor memory, and stores, in addition to an OS (not shown), an operation log storage program 207, an operation log grouping program 208, a client communication program 209, and a management console communication program 210. Those programs are parts of an operation log management program, and operation of each program is described later in detail.

The secondary storage device 204 is a storage device including a non-volatile, non-transitory storage medium for storing programs and data necessary for realizing predetermined functions. In FIG. 2, the secondary storage device 204 includes an operation log database (DB) 211, an association definition table 212, a group name table 213, and a grouping data DB 214. Those pieces of information are operation log management data. The stored information is described later in detail. The secondary storage device 204 may alternatively be an external storage device connected through the network 120.

For convenience of description, the programs 207 to 210 are illustrated in the main memory device 203, and the pieces of information (data) 211 to 214 necessary for the processing in the management server 100 are illustrated in the secondary storage device 204. However, typically, those programs and pieces of information (data) are loaded from a storage region of the secondary storage device 204 to a storage region of the main memory device 203 to be used by the CPU 201.

The CPU 201 realizes predetermined functions by executing programs while using data stored in the main memory device 203. For example, the CPU 201 operates in accordance with the operation log storage program 207, the operation log grouping program 208, the client communication program 209, and the management console communication program 210 to operate as an operation log storage part, an operation log grouping part, a client communication part, and a management console communication part, respectively. The management server 100 is a system including those functional parts.

In the examples of FIGS. 1 and 2, the management server 100 is one computer, but alternatively, for increased speed and reliability of the management processing, processing equivalent to that executed by the management server 100 may be executed by a plurality of computers. The plurality of computers are included in the operation log management system according to this embodiment. The client computer 130 may play a partial role in the management processing, and the management system may include the client computer.

As described above, the programs of the management server 100, the management console 110, and the client computer 130 are executed by the CPUs 201, 111, and 131 to execute predetermined processing using the storage devices 202, 112, and 132, and other devices. Therefore, a description made with a program as the subject according to this embodiment may be a description with the CPU 201, 111, or 131 as the subject. Alternatively, the processing executed by the programs is processing performed by the computers 100, 110, and 130 on which the programs run or by the computer system including the computers 100, 110, and 130.

As described above, the client computer 130 acquires the operation log of operations performed thereon by the user, and transmits the acquired operation log to the management server 100. Specifically, the operation log acquisition program 139 running on the client computer 130 acquires operation information (operation log) of the application programs 140. The processing method of the operation log acquisition program 139 is generally known and not a feature of this invention by itself, and hence a detailed description thereof is omitted here.

The manager communication program 138 of the client computer 130 transmits the operation log acquired by the operation log acquisition program 139 to the management server 100 through the network interface 137 and the network 120.

In the management server 100, the client communication program 209 receives the operation log transmitted from the client computer 130 through the network interface 206. The client communication program 209 passes the received operation log to the operation log storage program 207.

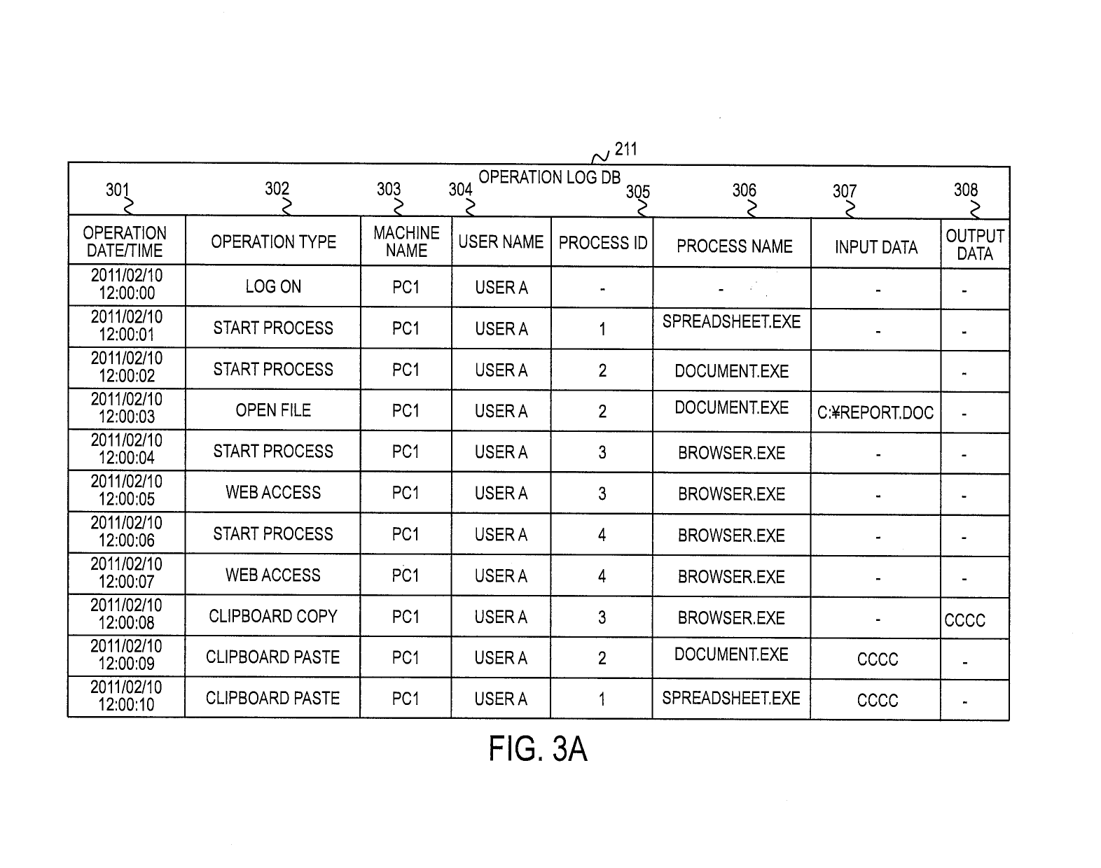

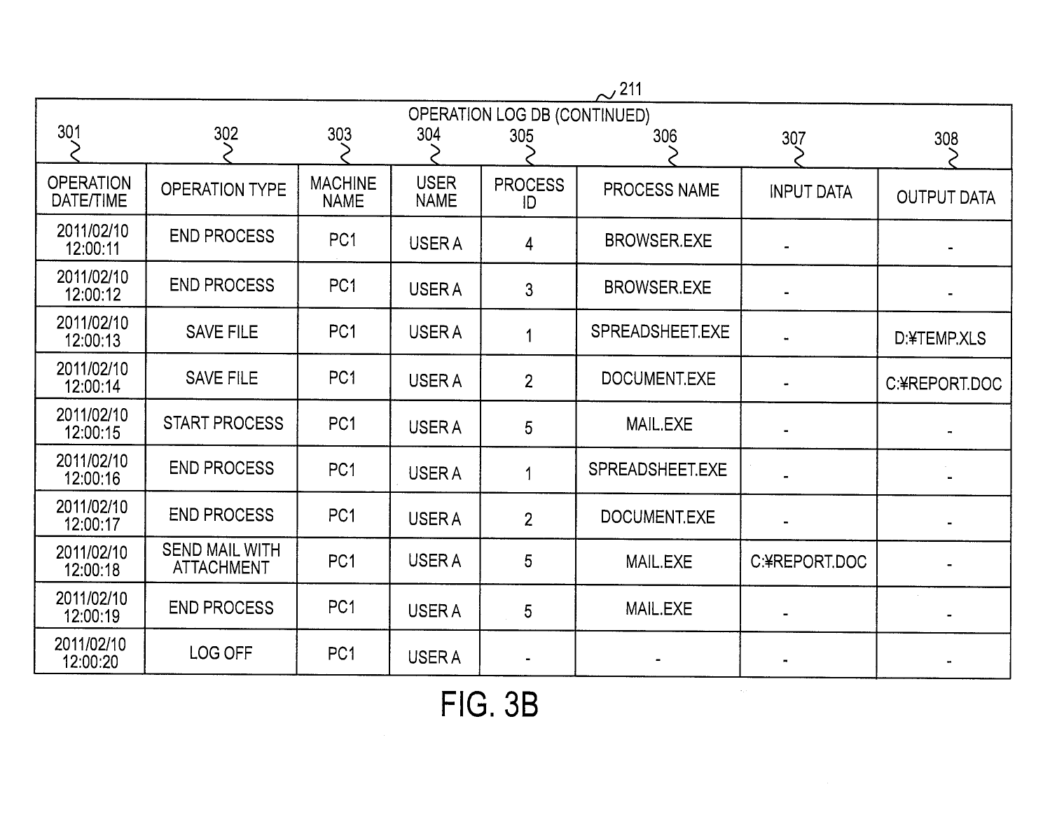

The operation log storage program 207 obtains data to be stored in the operation log DB 211 from the received operation log, and stores the data in the operation log DB 211. FIGS. 3A and 3B illustrate an example of the operation log DB 211 according to this embodiment. FIG. 3A illustrates a part of the operation log DB 211, and FIG. 3B illustrates another part (continued part) of the same operation log DB 211. In this example, the operation log DB 211 is represented by one table.

The operation log DB 211 in this example includes a column of operation date/time 301, a column of operation type 302, a column of machine name 303, a column of user name 304, a column of process IDs 305, a column of process name 306, a column of identifier of input data 307, and a column of identifier of output data 308. The operation log DB 211 further includes not-illustrated information, for example, an accessing URL of a Web access.

The operation date/time 301 indicates the date and time at which an operation was performed. The operation type 302 indicates a type of the operation performed by the user. This example illustrates, for example, operation types such as log on, start process, and open file. The machine name 303 is a name of the client computer on which the operation was performed. The machine name 303 is a unique identifier for identifying the client computer, and when there are a plurality of client computers, the plurality of client computers are allocated different machine names, respectively.

The user name 304 indicates a name of the user who logged in and performed an operation. When there are a plurality of users, the user name is a unique identifier in one client computer 130, and different user names are allocated to different users in one client computer 130. When there are a plurality of client computers, typically, the user name 304 is unique among all the client computers. When the client computer used by each user is fixed, different users may use the same user name.

The process ID 305 is an identifier for identifying a process in which the operation is performed. The process is an instance of a program. A plurality of processes generated from the same program may operate in parallel. The operation log acquisition program 139 may obtain a value of the process ID from, for example, the OS. As the process IDs 305, for example, numbers that increases monotonously are allocated to the processes according to the order in which the processes are generated. For example, numbers from a minimum value to a maximum value are allocated repeatedly in order.

For example, in FIG. 3A, as processes of the BROWSER.EXE program, a process with the process ID of 3 and a process with the process ID of 4 are illustrated. The process name 306 is a name of a process and is, for example, a name of a program. For example, in this example, BROWSER.EXE is a name of a WEB browser program, DOCUMENT.EXE is a name of a word processing program, and SPREADSHEET.EXE is a name of a spreadsheet program.

The input data 307 is indicated by the identifier of the input data and identifies input data received from an operation. Similarly, the output data 308 is indicated by the identifier of the output data and identifies the output data generated from the operation. The input data (identifier) and the output data (identifier) are described later.

In the example of FIGS. 3A and 3B, a plurality of operation log records (entries) included in the operation log DB 211 are arranged in order starting from the operation with the oldest operation date/time 301. Some of the operation log records store in all fields data specifically identifying details of the fields, but fields (fields indicated by hyphens) of some operation log records do not store such data. Typically, those fields store a NULL value.

Specifically, every operation log record stores specific data (data other than NULL) in the operation date/time 301, the operation type 302, the machine name 303, and the user name 304. Some operation log records do not contain the value of the process ID 305. Specifically, there is no specific process corresponding to a logon operation and a logoff operation. Therefore, those operation log records do not contain a specific process ID 305 and a specific process name 306.

In the example of FIGS. 3A and 3B, some operation log records store an identifier indicating a specific input data 307 or a specific output data 308. Specifically, particular input data exists for operations of “open file”, “clipboard paste”, and “send mail with attachment”, and the identifiers of the operations are stored in the operation log records. Further, particular output data exists for operations of “clipboard copy” and “save file”, and the identifiers of the operations are stored in the operation log records.

This example shows an operation log of operations by one user (user name: USER A) on one client computer 3 (machine name: PC1). However, when there are a plurality of client computers or a plurality of users, the operation log DB 211 stores an operation log for all the plurality of client computers or the plurality of users.

As described above, the operation log storage program 207 of the management server 100 obtains data of the operation log records from the operation log received from the client computer 130, and stores the obtained data in the operation log DB 211. In this configuration example, the operation log storage program 207 refers to the association definition table 212 to identify input information and output information of each operation.

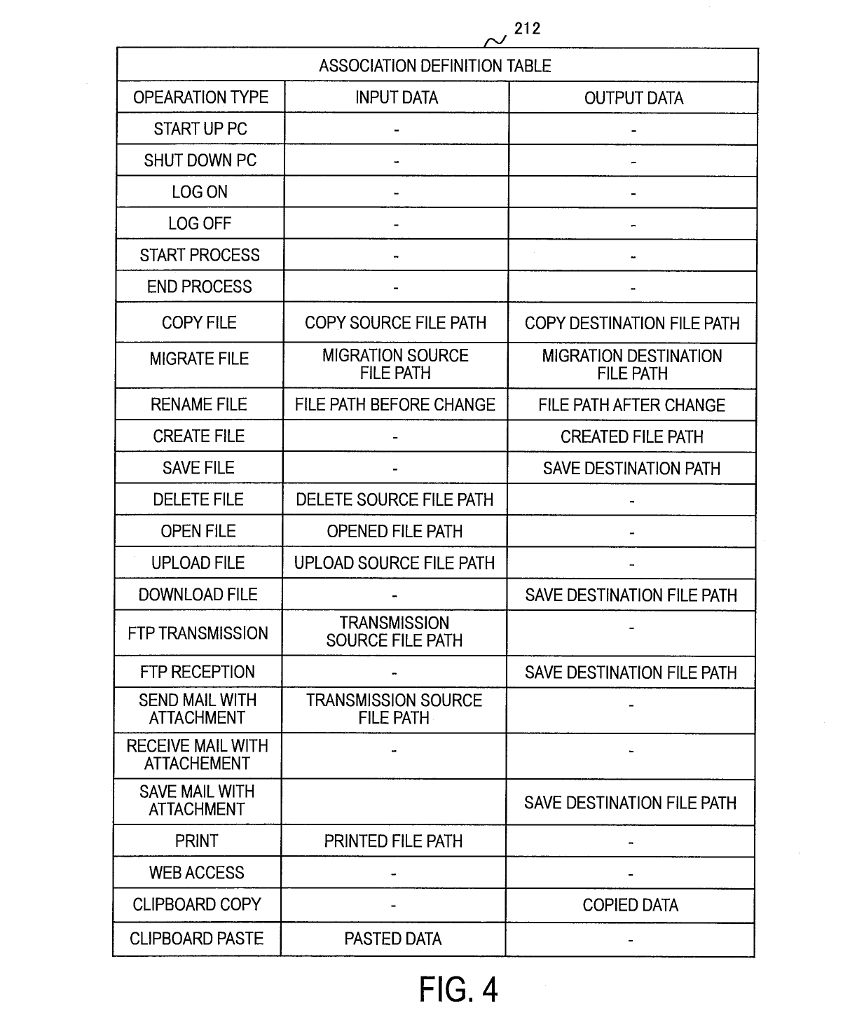

FIG. 4 illustrates an example of the association definition table 212. The association definition table 212 in this example includes a column of operation type, a column of type of the identifier identifying the input data, and a column of type of the identifier identifying the output data. As illustrated in FIG. 4, the input data and/or the output data is defined for some of the operation types, but no input data or output data is defined for other operation types. This is because there is no input/output data for those operations.

The operation type defined in the association definition table 212 is the same as the operation type registered in the operation log DB 211. It is preferred that all the operation types that can be stored in the operation log DB 211 have definitions in the association definition table 212 for their input/output data (including non-existence thereof).

In this example, for example, an input data identifier for the operation type “copy file” is an identifier indicating a copy source file path, and an output data identifier is an identifier indicating a copy destination file path. The operation type “copy file” has both the input data and the output data for one operation. It should be noted that, in the configuration example described in this embodiment, the file path is a full path of a file and includes directory information (storage address) and a file name (without directory information).

As another example, an input data identifier for the operation type “open file” is an identifier indicating an opened file path. For the “open file” operation, only the input data is defined, and only the input data identifier is allocated. In the example of the operation log DB 211 illustrated in FIG. 3A, the operation type of the fourth operation log record is “open file”, and the input data identifier thereof is “C:¥REPORT.DOC”. The input data identifier is a full path for a file name “REPORT.DOC”.

An input data identifier for the operation type “save file” is an identifier indicating a file save destination (full path). For the operation type “save file”, only the output data is defined, and only an output data identifier is allocated. In the example of the operation log DB 211 illustrated in FIG. 3B, the operation type of the fourth operation log record is “save file”, and the output data identifier thereof is “C:¥REPORT.DOC”.

In addition, in the association definition table 212 of FIG. 4, output data is defined for the operation type “clipboard copy”, and intput data is defined for the operation type “clipboard paste”. The “clipboard copy” operation includes an operation of maintaining copy source data (so-called copy operation) and an operation of deleting the copy source data (so-called cut operation).

Identifier types defined for the input data and the output data are “copied data” and “pasted data”, respectively. In the example of the operation log DB 211 illustrated in FIG. 3A, there is shown an example in which the operation log records of “clipboard copy” and “clipboard paste” have an input data identifier “CCCC” and an output data identifier “CCCC”.

As types of the input/output data identifiers associated with the operation type, appropriate types of identifiers are used by design. For example, as described above, in addition to the full path of data and the data itself, a hash value of data may be used. In the case of the clipboard, a program of the clipboard sequentially allocates identifiers to copy operations and cut operations, and the allocated identifiers may be used as the above-mentioned input data identifiers and output data identifiers.

The operation log storage program 207 identifies the identifier type of the input data and/or the output data for one operation in the operation log received from the client computer 130 by referring to the association definition table 212. When one or both of the input data and output data are defined, the operation log storage program 207 obtains the input data identifier and/or the output data identifier corresponding to the selected operation from the received operation log, and stores the obtained input data identifier and/or output data identifier in the operation log DB 211.

Typically, the operation log transmitted from the client computer 130 contains more detailed information on the user operation than information to be stored in the operation log DB 211. For example, the operation log storage program 207 determines, from a plurality of events (entries) included in the received operation log, operation types corresponding to those events according to the definition information, and selects, from those events, data, including the identifiers of the input/output data, to be stored in the operation log DB 211.

The operation log storage program 207 stores the thus-generated operation log records (specifically, data thereof) in the operation log DB 211. The operation log acquisition program 139 of the client computer 130 may transmit the operation log including values of the fields of the operation log records of the operation log DB 211 to the management server 100. The operation log storage program 207 may select operation log records (specifically, data thereof) from the received operation log and store the selected operation log records in the operation log DB 211. The operation log acquisition program 139 may transmit only data to be stored in the operation log DB 211 to the management server 100.

In this example, information for associating the operation type and the corresponding input/output data is illustrated in the association definition table 212 of FIG. 4. However, the definition information for associating the operation type and the input/output data does not need to be included in one table, and may have any data structure. The definition information may be included in the operation log storage program 207 without constituting a table.

The same applies to any information used by the management system according to this embodiment in the operation log management. Specifically, the operation log DB 211, the group name table 213, and the grouping data DB 214 are constituted of one or more tables, but information contained therein may be represented by any other data structure. Accordingly, according to this embodiment, information does not depend on the data structure.

In the following, grouping of the operation log records stored in the operation log DB 211 is described. The operation log grouping program 208 of the management server 100 executes the grouping.

The operation log grouping program 208 groups, in the operation log, the operation log records so that a plurality of operation log records presumed to be included in a series of operations are put in the same group. The grouping in this embodiment mainly includes two steps.

The first step is to determine a group to which the operation log record belongs from attributes of the operation log record. The operation log grouping program 208 refers to data included in the operation log record to determine the group of the log record. Specifically, in this step, the group to which the operation log record belongs is determined by a group identifier included in the operation log record, which, in this preferred configuration, is the process ID. Operation log records having the same process ID are put in the same group, and operation log records having different process IDs are put in different groups.

In the next step, different groups presumed to be included in a series of operations of the same task are associated with each other. The operation log grouping program 208 determines the relationship between the different groups by the output data (identifiers) and the input data (identifiers) of the operation log records belonging to the different groups.

With the relationship of the output data and the input data between the different groups, association of the series of operations performed through a plurality of processes may be appropriately recognized, and the user task may be appropriately estimated from the operation log of the client computer 130. By thus integrating a plurality of groups by the input/output data, the series of operations (group of operations) in the same task may be appropriately associated with each other.

Specifically, the operation log grouping program 208 associates different groups including operation log records whose output data (identifier) and input data (identifier) match. The operation log grouping program 208 presumes two groups including the operation log records whose output data (identifier) and input data (identifier) match to be included in a series of operations of the same task, and puts the two groups in an integrated group.

The operation log grouping program 208 determines association between the groups by the input/output data as described above, and generates one integrated group from a plurality of groups relating to each other. One group may relate to a plurality of groups by the input/output data, and one group may relate, through another related group, to still another group in succession. The integrated group includes the plurality of groups thus associated by the input/output data, and may include three or more groups.

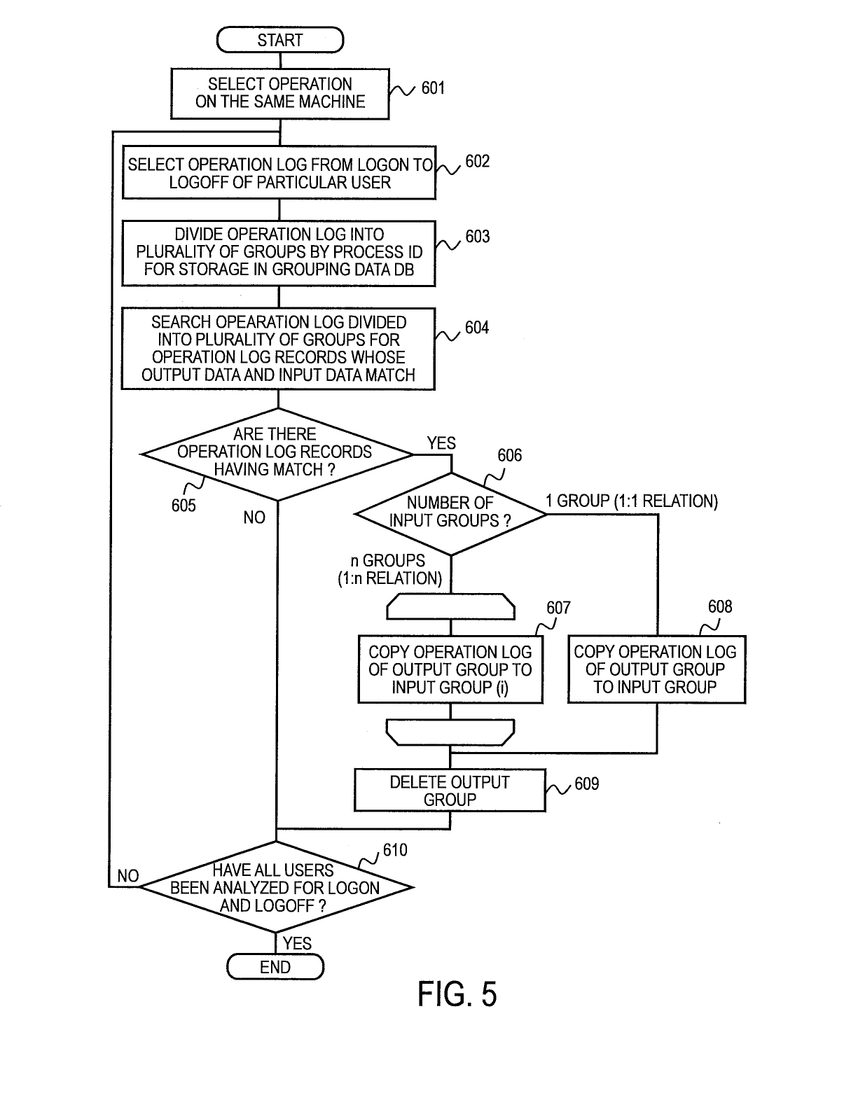

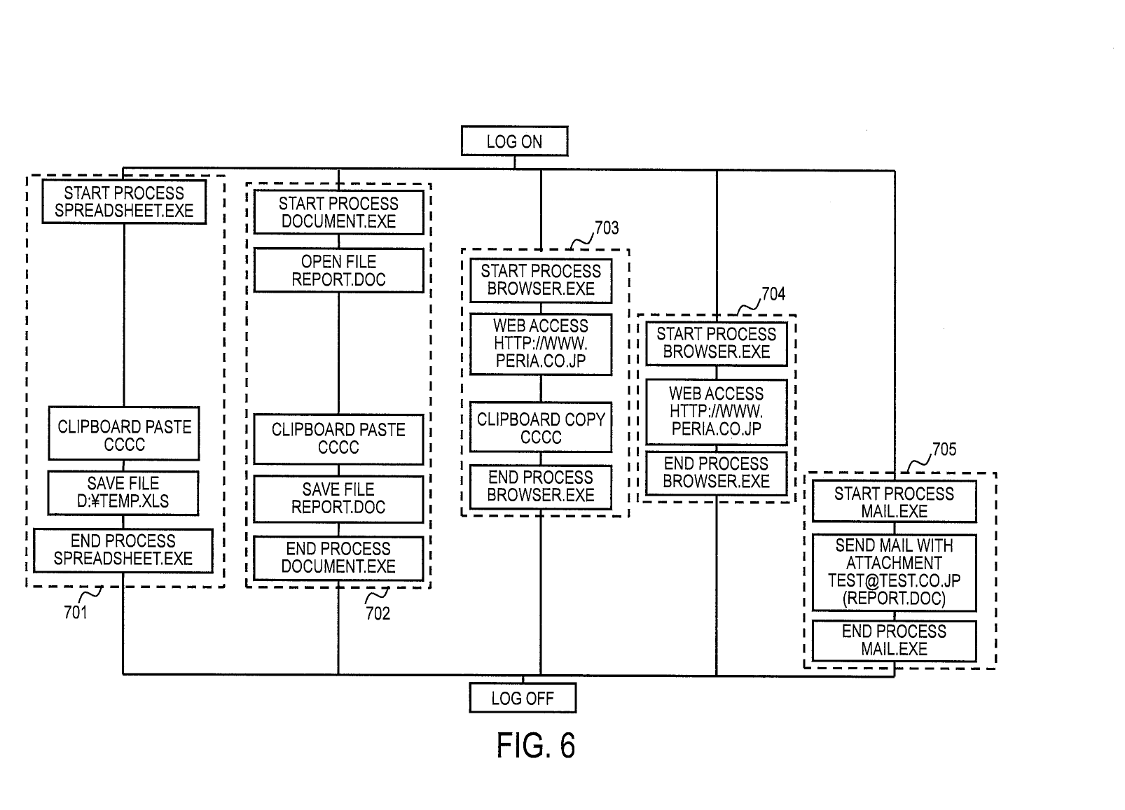

In the following, mainly referring to a flow chart of FIG. 5 and also referring to other drawings of FIGS. 6 to 14, an example of grouping of the operation log records by the operation log grouping program 208 is described. First, the manager uses the web browser 103 of the management console 110 to issue a request to display the operation log. The manager inputs the display request for an image on the display device 115 with the input device 116.

The display request is transferred to the management server 100 through the network I/F 117 of the management console 110 and the network 120, and the management console communication program 210 of the management server 100 receives the transferred display request through the network I/F 206. The management console communication program 210 makes a request of the operation log grouping program 208 to acquire information.

The operation log grouping program 208 executes the grouping processing illustrated in FIG. 5. The operation log grouping program 208 first selects, from the operation log DB 211, only operations on one and the same client computer 130 (601).

Next, the operation log grouping program 208 selects, from the selected operation log on the one client computer 130, an operation log from logon to logoff of a particular user (602). In Steps 601 and 602, the operation log from logon to logoff of the one particular user on the one client computer 130 is selected. The selected operation log is stored in the storage device 202.

Next, the operation log grouping program 208 divides the selected operation log into groups by the process IDs, and stores the groups obtained by the division in the grouping data DB 214 (603). Specifically, as described above, the operation log grouping program 208 refers to the process IDs of the operation log records of the selected operation log, and puts the operation log records having the same process ID in the same group.

FIG. 6 schematically illustrates a result of dividing the operation log records of the operation log DB 211 illustrated in FIGS. 3A and 3B into groups of the process IDs. A group 701 is a group of the operation log records with the process ID=1, a group 702 is a group of the operation log records with the process ID=2, a group 703 is a group of the operation log records with the process ID=3, a group 704 is a group of the operation log records with the process ID=4, and a group 705 is a group of the operation log records with the process ID=5.

In FIG. 6, blocks indicating operation records are arranged in chronological order of occurrence of operations from login to logoff. Each block includes the operation type and an identifier of the input/output data (input data or output data). Operations in the same group are arranged in the same column, and different groups are arranged in different columns.

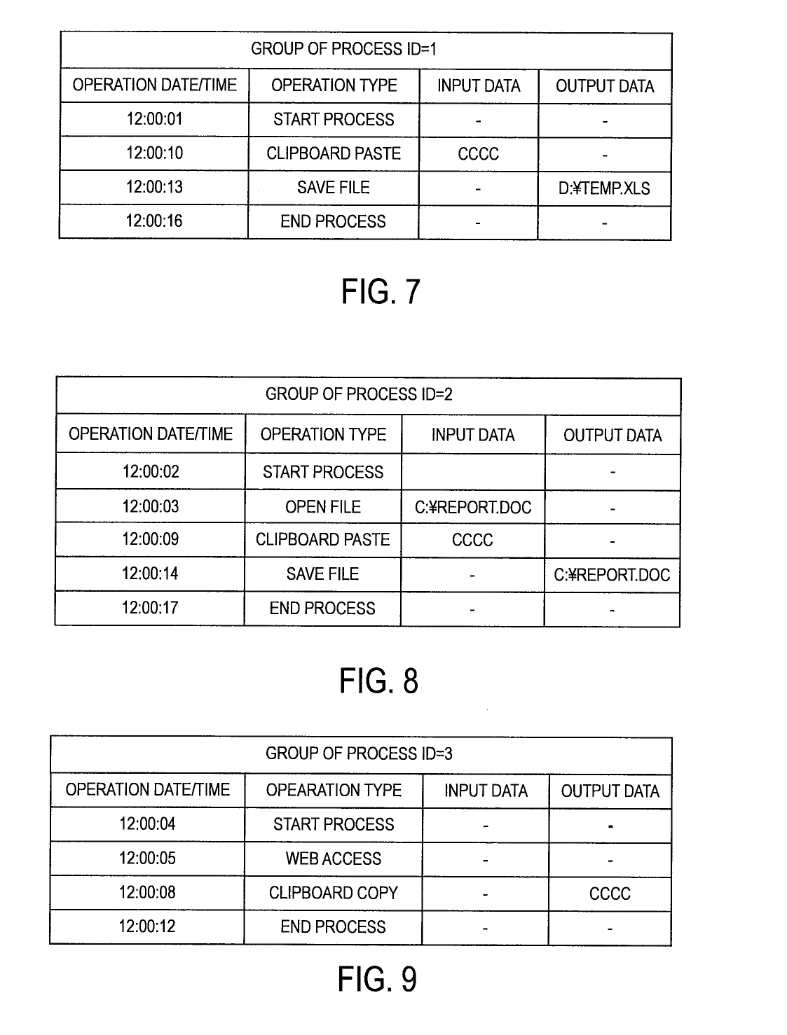

Tables of FIGS. 7 to 11 show operation log records of the group of the process ID=1, the group of the process ID=2, the group of the process ID=3, the group of the process ID=4, and the group of the process ID=5, respectively. The operation log records are stored in the grouping data DB 214. Each table includes columns of operation date/time, operation type, input data, and output data. Other columns may also be included.

FIGS. 7 to 11 each illustrate the group of each process ID as one table for convenience. However, as described above, information on the results of the grouping by the process IDs may be represented by any data structure. The information included in the results of the grouping by the process IDs depends on design.

Next, the operation log grouping program 208 searches the operation log records divided into the groups by the process IDs for operation log records whose output data (identifier) and input data (identifier) match (604). The search is performed for those in the relationship of operation log records belonging to different groups, and excludes matches of the output data (identifier) and the input data (identifier) within the same group.

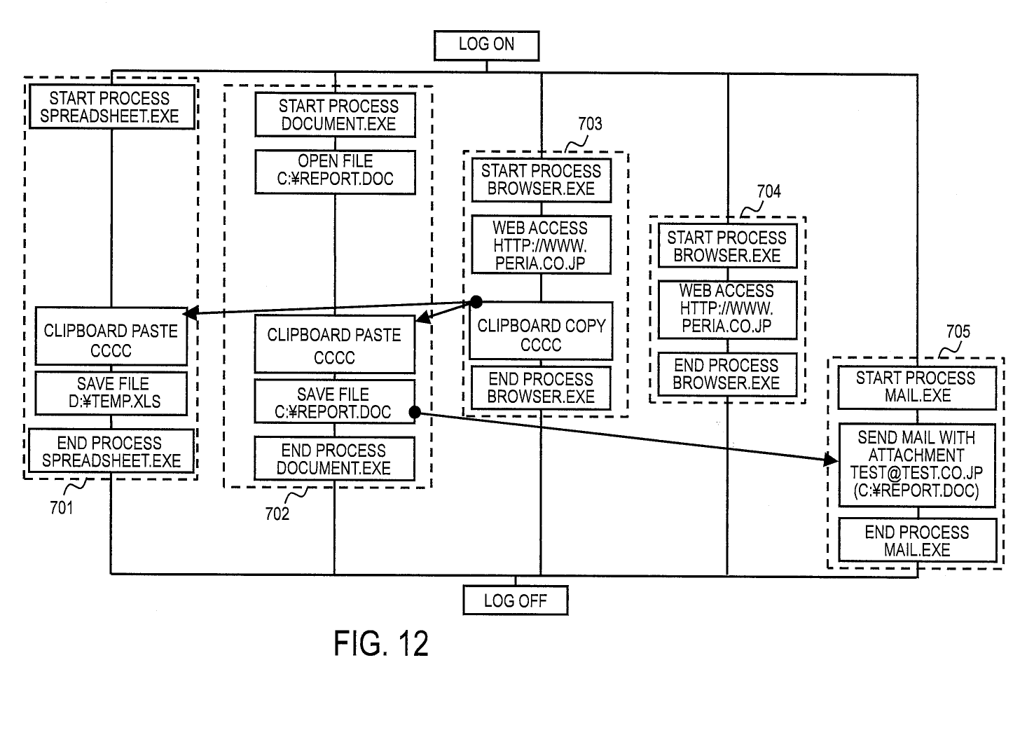

When operation log records whose output data and input data match are found in this search, the operation log grouping program 208 presumes the groups to which the operation log records belong to relate to each other. FIG. 12 illustrates the operation log records of different groups whose output data and input data match in this example. The arrows in FIG. 12 indicate transitions of data between groups.

In FIG. 12, the output data of the operation log record of “clipboard copy” in the group 703 of the process ID=3 is “CCCC”. The input data of the operation log record of “clipboard paste” in the group 701 of the process ID=1 is also “CCCC”. The input data of the operation log record of “clipboard paste” in the group 702 of the process ID=2 is also “CCCC”.

The operation log grouping program 208 determines that the operation log record of “clipboard copy” of the group 703 and the operation log record of “clipboard paste” of the group 701 relate to each other, and, assuming the groups 703 and 701 to which the operation log records belong to be a series of operation groups of the same task, associates the groups 703 and 701 with each other.

Similarly, the operation log grouping program 208 determines that the operation log record of “clipboard copy” of the group 703 and the operation log record of “clipboard paste” of the group 702 relate to each other, and associates the groups 702 and 703 to which the operation log records belong with each other.

It should be noted that, though not illustrated, in the case of the clipboard, the input data is changed each time the clipboard copy is performed by a copy operation or a cut operation. For example, it is assumed that, after the clipboard paste of the group 701 and before the clipboard paste of the group 702, another group (suppose group k) performs clipboard copy by a copy operation or a cut operation. In this case, the group 702 is associated with the group k and not with the group 703. In other words, the group 702 is prevented from being associated with the group 703 that performed the clipboard copy before the last clipboard copy (immediately before the group k).

Further, the output data of the operation log record of “save file” in the group 702 of the process ID=2 is “C:¥REPORT.DOC”. The input data of the operation log record of “send mail with attachment” in the group 705 of the process ID=5 is also “C:¥REPORT.DOC”.

The operation log grouping program 208 judges that the operation log record of “save file” of the group 702 and the operation log record of “send mail with attachment” of the group 705 relate to each other, and, presuming that the groups 702 and 705 to which the operation log records belong to be a series of operation groups of the same task, associates the groups 702 and 705 with each other.

It should be noted that the output data of the “open file” operation and the input data of the “save file” operation in the group 702 match, but the operations are not associated because the operations belong to the same group.

In the following description, the group (group at the tail of the arrow) having the operation log record of the output data is referred to as an output group, and the group (group at the head of the arrow) including the same data as the output data in the operation log record of the input data is referred to as an input group. In this example, the group 703 is an output group. The groups 701 and 705 are input groups. The group 702 is an input group and also is an output group.

When the result of the search in Step 604 indicates that there are operation log records having a match (605: YES), the operation log grouping program 208 proceeds to Step 606. When there is no operation log record having a match (605: NO), the operation log grouping program 208 proceeds to Step 610.

In Step 606, the operation log grouping program 208 judges the number of groups having the same input data with respect to one piece of output data in the operation log records thereof. When the number is 1, the operation log grouping program 208 proceeds to Step 608. In this example, with respect to the output data of the “save file” operation in the group 702, the number of groups having the same input data is 1, and the group is the group 705.

When the number is n (integer of 2 or greater), the operation log grouping program 208 proceeds to Step 607. In this example, with respect to the output data of the “clipboard copy” operation in the group 703, the number of groups having the same input data is 2, and the groups are the group 701 and the group 702.

In Step 607, the operation log grouping program 208 copies the operation log included in the output group to an input group i (each of a plurality of sequentially selected input groups). The operation log grouping program 208 executes Step 607 for all the groups found in Step 606.

In Step 608, the operation log grouping program 208 copies the operation log included in the output group to an input group. The operation log grouping program 208 does not necessarily need to copy the above-mentioned operation log, as long as the output group and the input group may be associated with each other to form the integrated group. For example, the operation log grouping program 208 stores information associating (defining) the groups constituting the integrated group in the storage device 202. This applies to Step 607.

In Step 609, the operation log grouping program 208 deletes the output group from the grouping data DB 214. In Step 610, the operation log grouping program 208 determines whether or not there remains a combination of logon and logoff for which the processing has not been performed yet.

When there is a combination of logon and logoff for which the processing has not been performed yet (610: NO), the operation log grouping program 208 returns to Step 602. When there is no combination of logon and logoff for which the processing has not been performed (610: YES), the operation log grouping program 208 ends the grouping processing.

In the examples illustrated in FIGS. 7 to 12, in Step 607 described above, the operation log in the group 703 of the process ID=3, which is an output group, is copied to each of the corresponding input group 701 (process ID=1) and input group 702 (process ID=2). In this manner, an integrated group of the group 703 and the group 701, and an integrated group of the group 703 and the group 702 are generated. The output group 703 is deleted from the grouping data DB 214 in Step 609.

Further, the operation log grouping program 208 copies the operation log in the group 702, which is an output group, to the corresponding input group 705 (process ID=5). The output group 702 is a group integrated with the group 703, and the operation log records in the group 702 and the group 703 before the integration are copied to the group 705. The output group 702 is deleted from the grouping data DB 214 in Step 609.

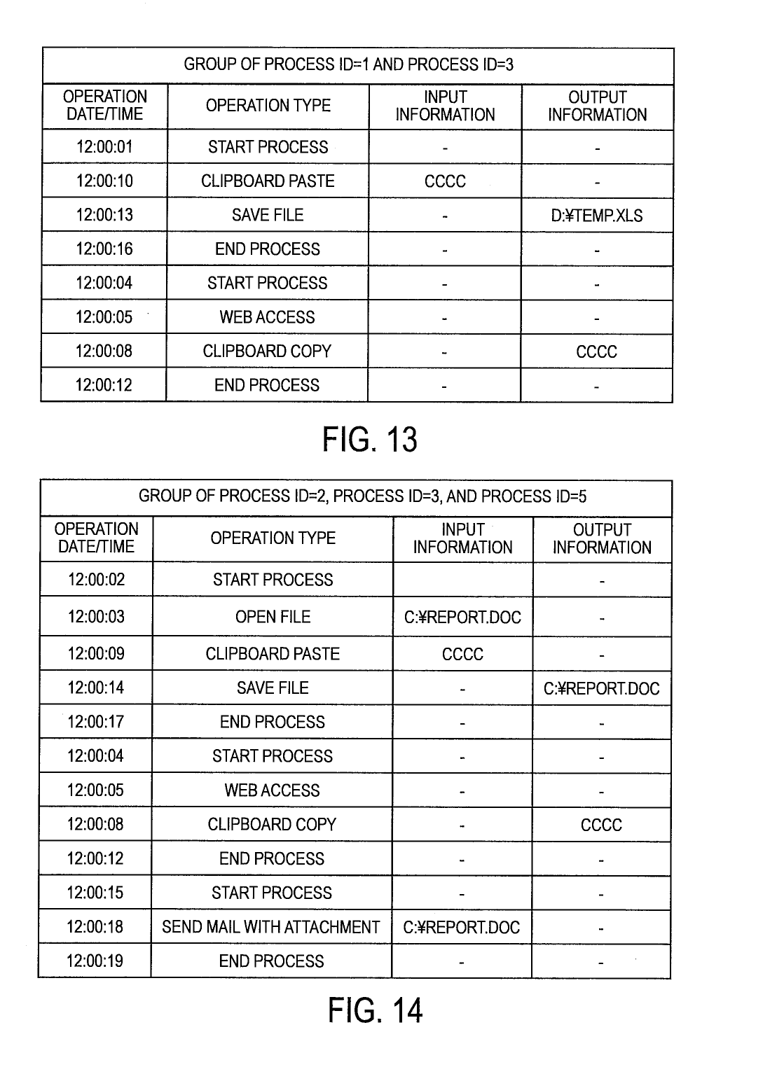

FIGS. 13 and 14 each illustrate operation log records of an integrated group. FIG. 13 illustrates a table of an integrated group of the group of the process ID=1 (see FIG. 7) and the group of the process ID=3 (see FIG. 9). FIG. 14 illustrates a table of an integrated group of the group of the process ID=2 (see FIG. 8), the group of the process ID=3 (see FIG. 9), and the group of the process ID=5 (see FIG. 11).

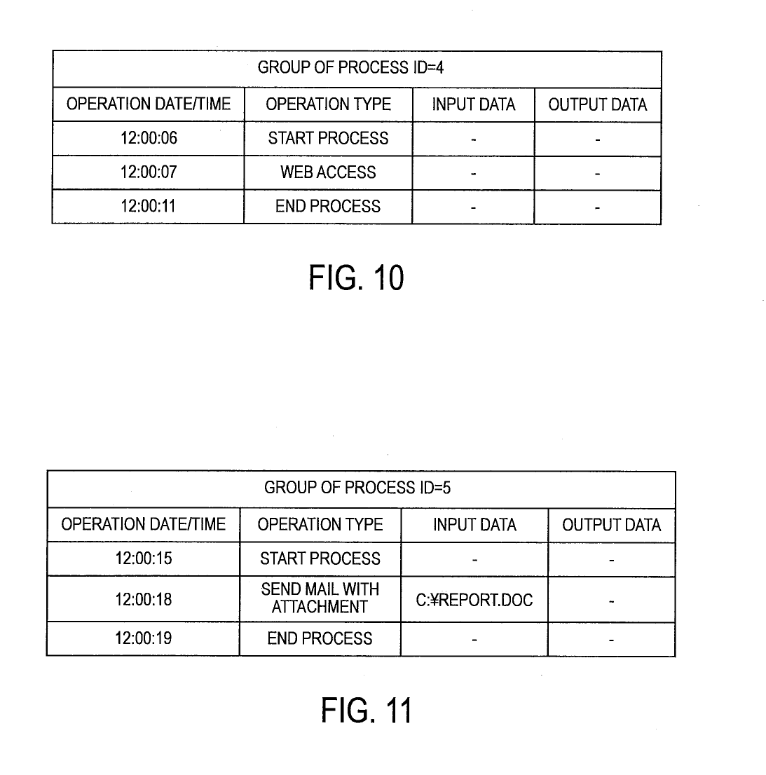

The grouping data DB 214 stores, in addition to information on the above-mentioned two integrated groups, the operation log records in the group of the process ID=4 (see FIG. 10), which is not integrated with any group or deleted. The integrated group includes all operations presumed to be operations performed by the user in the same task. The three groups are presumed to correspond to different user tasks, respectively.

The operation log grouping program 208 determines, based on the output data from a group and the input data to another group, association between the groups. As is apparent from the above description, in an associated pair of an operation of outputting data (output operation) and an operation of receiving data (input operation), the input operation comes after the output operation. The operation log grouping program 208 searches input operations executed after an output operation for an input operation whose output data and input data match.

In order to avoid associating two operations which handle the same data or data with the same identifier but are unrelated, typically, the operation log grouping program 208 searches operations within a predetermined number of steps or operations in a predetermined time period from the output operation for an operation whose input data matches with the above-mentioned output data.

Typically, the operation log grouping program 208 associates related operations based on the input data and the output data in accordance with the time series of the operation execution date/time. Thereafter, the operation log grouping program 208 integrates the related groups in accordance with the chronological order of the associated pairs of an output operation and an input operation.

For example, when the operation log of the output group is to be copied to the input group in the group integration, the operation log grouping program 208 sequentially selects the associated pairs of an output operation and an input operation in chronological order of the execution date/time, and copies the operation log of the output group to the corresponding input group. As described above, one output operation may form a plurality of pairs with a plurality of input operations, and one output group may be copied to a plurality of input groups.

As described above, 3 or more groups may be integrated in one group in succession. The operation log grouping program 208 integrates the output group with the input group, and repeats the integration to generate the final integrated groups. When the input group is copied to another input group in a subsequent step as an output group, all the operation log records that have been integrated are copied (example of integrating the group 702 to the group 705 in FIG. 12). The group which is an input group and also is an output group associates other two groups with each other.

The example illustrated in FIG. 5 starts grouping the operation log records in response to a request from the management console 110. The management server 100 may execute acquisition and grouping of the operation log records in the operating client computer 130 in parallel without waiting for the external request.

As described above, in a preferred example, the operation log grouping program 208 groups operations of the same login user in the same client computer. This way, it is possible to estimate a series of operations of the same task by one user appropriately and efficiently.

Alternatively, the operation log grouping program 208 may group operation log records of a plurality of client computers. In addition to grouping the operation log records in a plurality of client computers by the same user, the operation log grouping program 208 may group operation log records in a plurality of client computers by a plurality of users. In the processing described with reference to FIG. 5, the operation log grouping program 208 omits selection of the operation log in the same client computer (601) and/or selection of the operation log of the same user (602).

As described above, the operation log grouping program 208 performs the grouping in the operation log from logon to logoff, to thereby identify and display a task of the user through efficient processing. Alternatively, the operation log grouping program 208 may group the operation log records in a plurality of periods from logon to logoff, to thereby identify and display the task of the user.

The operation log grouping program 208 may group the operation log records of a plurality of client computers, which are a selected part of the client computers from which the operation log records are acquired, or may group the operation log records of a plurality of users, who are a part of a plurality of users whose operation log records are acquired.

As in this example, it is preferred that one process ID be used to generate one corresponding group. However, depending on the design, different process IDs are associated with each other so that the process IDs are put in the same group.

In a preferred configuration, the operation log grouping program 208 groups the operation log records by the process ID. However, an attribute value that is different from the process ID may be used as the group identifier. For example, the operation log grouping program 208 groups the operation log records by a window identifier (for example, an identifier called “window handle”). The operation log grouping program 208 may obtain the window identifier from, for example, the OS.

The window identifier identifies a window on a screen, and for example, different window identifiers are allocated to a plurality of child windows in a parent window of Multiple Document Interface (MDI), respectively. When the client computer 130 uses Tabbed Document Interface (TDI) and one window switchably displays a plurality of documents by tabs, different window identifiers are allocated to the tabs, respectively. In this manner, the term “window” is not limited to a single window and may include a child window and a tab in a window.

Alternatively, the operation log grouping program 208 may use a thread ID as the group identifier. In this manner, the operation log grouping program 208 may group the operation log records by an identifier of an object to be subjected to an operation, such as a process, window, or thread to be subjected to an operation.

In order to associate the groups of different client computers 130 by the output data and the input data thereof, the operation log grouping program 208 identifies the output data and the input data by using hash values thereof, for example. When a file is communicated between the client computers 130, the file received at a transmission destination cannot be identified only by a path in the client computer 130 at the transmission source. The operation log grouping program 208 may use hash values of the communicated data to accurately determine whether or not there is a match of the output data and the input data between different computers 130.

The association definition table 212 illustrated in FIG. 4 is a table for associating the groups in one client computer 130. Definitions of the output data and the input data in communication between different client computers 130 are different from those within one client computer 130. In the communication between the computers, the output data is transmitted data, and the input data is received data.

For example, in the association definition table 212 of FIG. 4, for an FTP transmission operation within the client computer 130, the type of the input data is defined to be a transmission source file path. For an FTP transmission operation in communication between the client computers 130, the type of the identifier of the output data is defined to be a hash value of the transmitted data.

In the association definition table 212 of FIG. 4, for an FTP reception operation within the client computer 130, the type of the output data is defined to be a save destination file path. For an FTP reception operation in communication between the client computers 130, the type of the identifier of the input data is defined to be a hash value of the received data.

In order to identify data communicated between the client computers 130, the operation log grouping program 208 may use sockets at the transmission source and the transmission destination used in the communication. A socket is a combination of a protocol (TCP or UDP) and a port number. IP addresses, protocol identification information, and port numbers of the transmission source and the transmission destination of the data are included. The operation log grouping program 208 refers to those pieces of information, to thereby associate the data communicated between processes of different client computers 130, and an output process and an input process thereof.

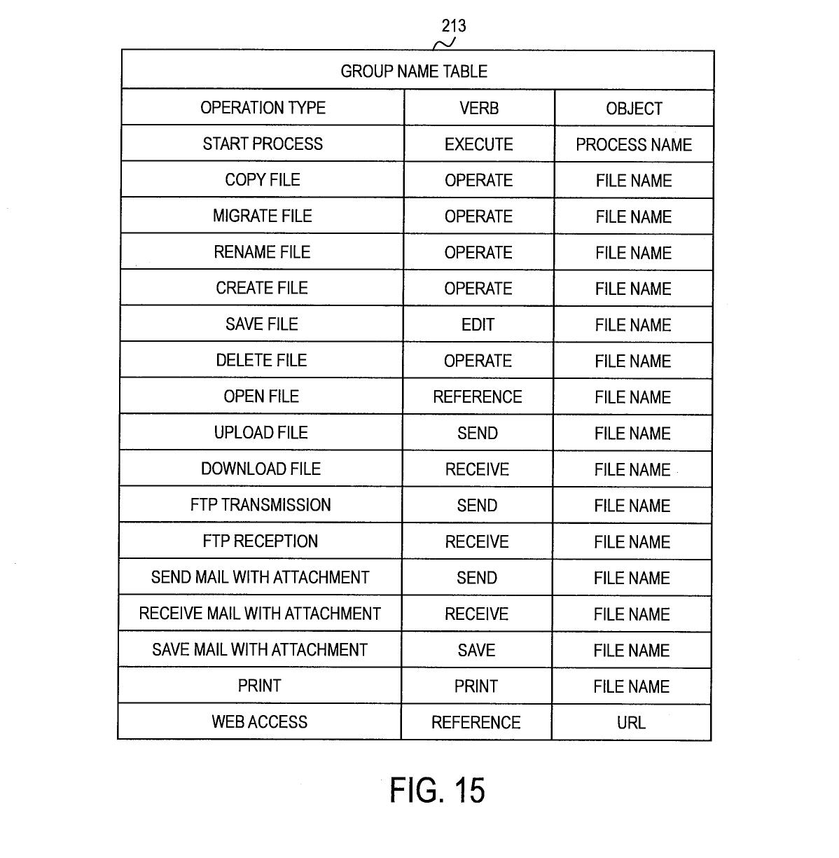

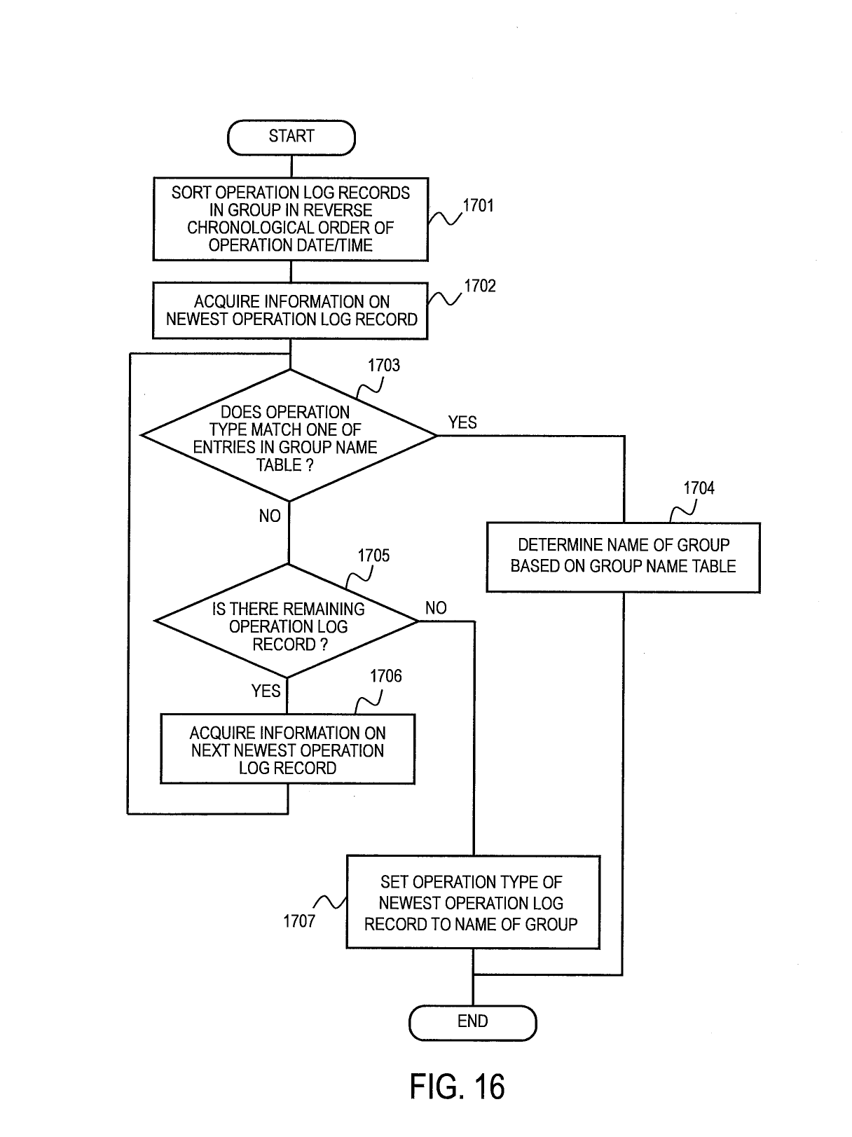

The operation log management program according to this embodiment names results of grouping (groups). This allows the manager to immediately recognize the task performed by the user, with the result that the user task management by the manager can be supported more effectively. In the following, the determination method is described with reference to a flow chart of FIG. 16. In this example, the operation log grouping program 208 refers to the group name table 213 exemplified in FIG. 15 to determine a name of each group (including integrated and non-integrated groups).

In the example illustrated in FIG. 15, the group name table 213 defines, for an operation type, a verb and a data type of an object thereof. The task name of a group (integrated or non-integrated group) is generated by combining the verb and the object. For example, when a name is determined by a “start process” operation, the name is “execute” “process name” (the process name depends on each operation).

The operation log grouping program 208 identifies an operation type of an operation log record selected from the group, and selects the verb and the data type of the object associated with the operation type from the group name table 213. The operation log grouping program 208 acquires data of the data type of the selected object from the operation log DB 211 and generates a name of the group (task) from the data of the verb and the object.

As described above, the operation log grouping program 208 sequentially selects the groups obtained by the grouping to generate names of the groups (tasks) in accordance with the flow chart of FIG. 16. The operation log grouping program 208 first sorts the operation log records in the selected group (task) in reverse chronological order (1701). This step may be omitted.

Next, the operation log grouping program 208 selects information on the newest operation log record (1702). When the operation type of the selected operation log record matches one of the entries in the group name table 213 (1703: YES), the operation log grouping program 208 proceeds to Step 1704. When the operation type of the selected operation log record does not match any of the entries (1703: NO), the operation log grouping program 208 proceeds to Step 1705.

In Step 1704, the operation log grouping program 208 refers to the group name table 213 to identify the verb and the data type of the object of the selected operation type, and acquires data of the data type of the object from the operation log DB 211. The operation log grouping program 208 further generates a name of the task (group) from the acquired data of the verb and the object.

In Step 1705, the operation log grouping program 208 determines whether or not there is a remaining operation log record of the group that is yet to be checked. When there is a remaining operation log record (1705: YES), the operation log grouping program 208 proceeds to Step 1706. When there is no remaining operation log record (1705: NO), the operation log grouping program 208 proceeds to Step 1707.

In Step 1706, the operation log grouping program 208 acquires information on the newest operation log record next to the operation log record selected last time, that is, information on the newest operation log record in the remaining operation log records. Thereafter, the operation log grouping program 208 returns to Step 1703.

In Step 1707, because there is no operation (operation log record) for generating the name of the task (group) in the operation log of the group, the operation log grouping program 208 uses the operation type of the newest operation log record in the group to generate the name of the group.

By determining the group name in accordance with the information in the operation log of the group as in the above-mentioned method, an appropriate name may be given to the task of the group. Further, by preparing the definition information for associating the operation type and the task name in advance and determining the task name (group name) based on the operation type and the definition information selected from the group, a more appropriate name may be given to the task of the group.

As described above, in order to generate a more appropriate name, especially in the configuration in which the grouping is performed by the process ID, it is preferred to generate a name based on the operation type of the newest operation of the operation log in the group, of the operation types defined in the definition information (in this example, group name table 213). This is because the purpose of the task is often the last or near the last operation.

However, the operation log grouping program 208 may generate a name based on an operation type selected by a method different from the above method. For example, priorities may be given to the operation types, and the operation log grouping program 208 may select the operation type to be used in determining the name in accordance with the priorities.

The operation log grouping program 208 does not necessarily need to use the definition information. The group name table 213, which is the definition information in this example, indicates the verb and the data type of the object associated with the operation type, but a different method of determining the name may alternatively be used. For example, the operation log grouping program 208 may use the operation type instead of the verb to generate a name that does not include a part corresponding to the verb.

Next, display of information of grouped operation log records is described. After grouping the operation log records and giving a name to the group, the operation log grouping program 208 transmits the processing result to the management console 110. The operation log grouping program 208 uses the management console communication program 210 to transmit the processing result to the management console 110 through the network I/F 206 and the network 120.

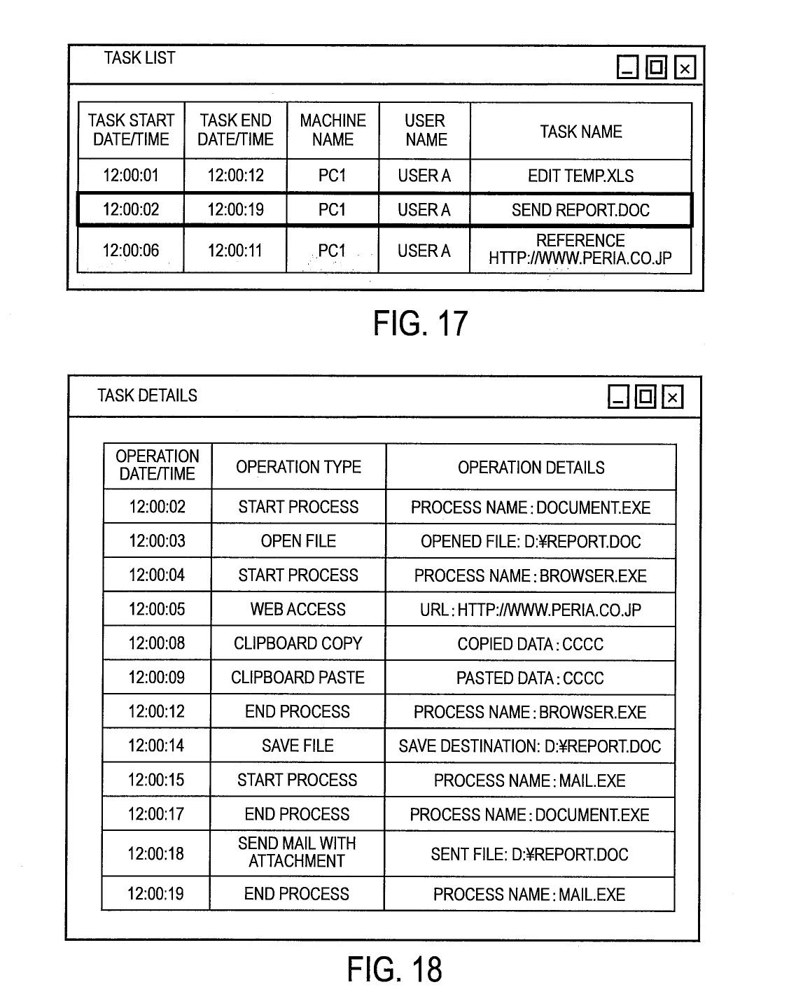

The management console 110 receives the above-mentioned processing result through the network I/F 117, and stores the received processing result in the storage device 112. The web browser 103 displays the received processing result on the display device 115. FIGS. 17 and 18 each illustrate a display example of the grouped operation log records.

FIG. 17 illustrates a display example of a task list. This list allows the manager to check tasks performed by the managed user. Each of the displayed tasks corresponds to the integrated or non-integrated group. Each entry includes fields of task start date/time, task end date/time, machine name (client computer name), user name, and task name.

In this example, the top entry is a task of the integrated group of the group of the process ID=1 and the group of the process ID=3 illustrated in FIG. 13. The middle entry is a task of the integrated group of the group of the process ID=2, the group of the process ID=3, and the group of the process ID=5 illustrated in FIG. 14. The bottom entry is a task of the group of the process ID=4 illustrated in FIG. 10.

The task names are determined by the method described with reference to FIG. 16. As illustrated in FIG. 13, in the integrated group of the process ID=1 and the process ID=3, the operation with the newest operation date/time registered in the group name table 213 is the operation “save file” at “12:00:13”.

As illustrated in FIG. 15, the verb of the operation “save file” is “edit”, and the data type of the object is a file name. The file name in this example is “TEMP.XLS”. As illustrated in FIG. 17, the task name of the top entry is “edit TEMP.XLS”.

Task names of the other two entries in the task list of FIG. 17 are also determined similarly to the first entry. The middle entry indicates the task of the integrated group of the process ID=2, the process ID=3, and the process ID=5 illustrated in FIG. 14. The operation log grouping program 208 selects the operation (entry) “send mail with attachment” at “12:00:18” from the table of FIG. 14. As illustrated in FIG. 15, in the group name table 213, the verb of the operation “send mail with attachment” is “send”, and the object is a file name. In this example, the file name is “REPORT.DOC”.

The bottom entry indicates the task of the group of the process ID=4 illustrated in FIG. 10. The operation log grouping program 208 selects the operation (entry) “WEB access” at “12:00:07” from the table of FIG. 10. As illustrated in FIG. 15, in the group name table 213, the verb of the operation “WEB access” is “reference”, and the object is a URL.

FIG. 18 illustrates a display example of task details, and more specifically, task details of the second task “send REPORT.DOC” of the task list illustrated in FIG. 17. Specifically, the task details show operations included in the selected group of tasks. The table in this example includes columns of operation date/time, operation type, and operation details.

The column of operation details shows specific target and content of the operation. The data type displayed in the operation details is defined in the definition information in advance, and the operation log grouping program 208 may acquire the data from the operation log DB 211. The operation details of FIG. 18 allow the manager to check all operations included in the selected task.

As described above, it is preferred that the operation log management system give a task name to the group which is obtained by grouping the operation log records and expected to be included in the same task, and display the name as information representing the group, but another value may alternatively be displayed. It is preferred that the operation log management system display the task list and further display details of the task selected from the list. However, the task list and the task details may be displayed simultaneously, or only one of the task list and the task details may be generated for display.

Hereinabove, an embodiment of this invention has been described, but it is not intended to limit this invention to the above-mentioned embodiment. A person having ordinary skill in the art may easily change, add, or convert elements of the above-mentioned embodiment within the scope of this invention.

Some or all of the above-mentioned configurations and functions may be realized by hardware obtained by designing, for example, an integrated circuit. Information realizing the functions, such as programs, tables, and files, may be stored in a storage device such as a non-volatile semiconductor memory, a hard disk drive, or a solid state drive (SSD), or a computer-readable non-transitory data storage medium such as an IC card, an SD card, or a DVD.

The management system may include, in addition to the above-mentioned management server and management console, a plurality of management servers for collecting operation logs in a plurality of client computers. A central management server collects the operation logs from the plurality of other management servers and performs grouping of operation log records and generation of data for displaying user tasks.

What is claimed is:

1. An operation log management system comprising a processor, a storage device and a display device for managing a user operation log in at least one client computer, wherein:
the storage device stores a plurality of operation log records obtained from an operation log in the at least one client computer;
the plurality of operation log records each contains an operation type of a corresponding operation and a group identifier for identifying a group to which the corresponding operation belongs;
each of at least a part of the plurality of operation log records contains at least one of an identifier of input data and an identifier of output data of a corresponding operation;
the processor groups the plurality of operation log records into a plurality of groups by the group identifiers;
the processor identifies operation log records which belong to different groups and whose output data identifier and input data identifier match;
the processor associates the different groups to which the identified operation log records belong as components of one integrated group; and
the display device displays information representing the integrated group.

2. An operation log management system according to claim 1, wherein the group identifier is a process identifier for identifying a process, which is an instance of a program.

3. An operation log management system according to claim 2,
wherein the storage device stores task name definition information for associating operation types and names representing user tasks, and
the processor refers to the task name definition information to determine a name representing a user task corresponding to an operation type of an operation log record selected from the integrated group.

4. An operation log management system according to claim 3,
wherein the storage device stores definition information defining input data and output data corresponding to operation types,
the processor refers to the definition information to determine input data identifiers and output data identifiers corresponding to operation types of user operations in the operation log in the at least one client computer, and
each of the at least a part of the plurality of operation log records contains at least one of an input data identifier and an output data identifier determined by the processor.

5. An operation log management system according to claim 4, further comprising an input device,
wherein, in response to an input from the input device to the information representing the integrated group, the display device further displays information on operation log records included in the integrated group.

6. An operation log management system according to claim 5,
wherein the processor selects, in the operation log acquired in the at least one client computer, an operation log by one login user, and
the plurality of operation log records stored in the storage device are operation log records of the selected operation log by the one login user.

7. An operation log management system according to claim 6,
wherein the processor selects, in the operation log acquired in the at least one client computer, an operation log in one client computer, and
the plurality of operation log records contained in the operation log are operation log records of the selected operation log in the one client computer.

8. An operation log management method of managing a user operation log in at least one client computer by a management system, comprising:
storing, by the management system, a plurality of operation log records obtained from an operation log in the at least one client computer, the plurality of operation log records each containing an operation type of a corresponding operation and a group identifier for identifying a group to which the corresponding operation belongs, each of at least a part of the plurality of operation log records containing at least one of an identifier of input data and an identifier of output data of a corresponding operation;
grouping, by the management system, the plurality of operation log records into a plurality of groups by the group identifiers;
identifying, by the management system, operation log records which belong to different groups and whose output data identifier and input data identifier match;
associating, by the management system, the different groups to which the identified operation log records belong as components of one integrated group; and
displaying, by the management system, information representing the integrated group.

9. An operation log management method according to claim 8, wherein the group identifier is a process identifier for identifying a process, which is an instance of a program.

10. An operation log management method according to claim 8, further comprising:
storing, by the management system, task name definition information for associating operation types and names representing user tasks, and
refering to, by the management system, the task name definition information to determine a name representing a user task corresponding to an operation type of an operation log record selected from the integrated group.

11. An operation log management method according to claim 8, further comprising:
storing, by the management system, definition information defining input data and output data corresponding to operation types,
refering to, by the management system, the definition information to determine input data identifiers and output data identifiers corresponding to operation types of user operations in the operation log in the at least one client computer, and
wherein each of the at least a part of the plurality of operation log records contains at least one of an input data identifier and an output data identifier determined by the processor.

12. An operation log management method according to claim 8, further comprising, in response to an input to the information representing the integrated group, displaying, by the management system, information on operation log records included in the integrated group.

13. An operation log management method according to claim 8, further comprising selecting, by the management system, an operation log by one login user in the operation log acquired in the at least one client computer, and
wherein the plurality of operation log records are operation log records of the selected operation log by the one login user.

14. An operation log management method according to claim 8, further comprising selecting, by the management system, in the operation log acquired in the at least one client computer, an operation log in one client computer,
wherein the plurality of operation log records contained in the operation log are operation log records of the selected operation log in the one client computer.

15. An operation log management system for managing a user operation log in at least one client computer, comprising:
an operation log storage part for storing a plurality of operation log records obtained from an operation log in the at least one client computer, the plurality of operation log records each contains an operation type of a corresponding operation and a group identifier for identifying a group to which the corresponding operation belongs, each of at least a part of the plurality of operation log records contains at least one of an identifier of input data and an identifier of output data of a corresponding operation;
a grouping part for grouping the plurality of operation log records into a plurality of groups by the group identifiers;
an identifying part for identifying operation log records which belong to different groups and whose output data identifier and input data identifier match;
an associating part for associating the different groups to which the identified operation log records belong as components of one integrated group; and
a display part for displaying information representing the integrated group.
